(19) United States
(12) Patent Application Publication
(10) Pub. No.: US 2009/0188926 A1
(43) Pub. Date: Jul. 30, 2009

(54) REFUSE CONTAINER AND METHOD FOR REFURBISHING REFUSE CONTAINERS

(76) Inventor: Kenneth A. Shirey, Edmond, OK (US)

Correspondence Address: DUNLAP CODDING, P.C., PO BOX 16370, OKLAHOMA CITY, OK, 73113, US

(21) Appl. No.: 12/361,681

(22) Filed: Jan. 29, 2009

Related U.S. Application Data
(60) Provisional application No. 61/024,270, filed on Jan. 29, 2008.

(51) Int. Cl. B65F 1/02; B65F 1/14; B23P 6/00

(52) U.S. Cl. 220/601; 220/628; 220/639; 29/402.08

(57) ABSTRACT

A refuse container having a metal container body, a polymeric cover having a bottom sized to extend across a lower end of the metal container body and a flange extending upwardly from the bottom and connected to the metal container body so as to close the lower end of the metal container body.

### CROSS REFERENCE TO RELATED APPLICATIONS

This application claims benefit of U.S. Provisional Application No. 61/024,270, filed Jan. 29, 2008, which is incorporated herein by reference in its entirety.

### BACKGROUND OF THE INVENTION

1. Field of the Invention

This invention relates to refuse containers, and more particularly, but not by way of limitation, to a refuse container in combination with a polymeric cover. Also, this invention relates to methods for refurbishing deteriorated refuse containers.

2. Brief Description of Related Art

Refuse containers, particularly commercial refuse containers, are typically fabricated from reactive metals such as steel, as fabricating refuse containers from non-reactive materials can be cost prohibitive. Generally, refuse containers are constructed having a plurality of side walls joined together to form a container body which resembles a rectangular tube. The top of the refuse container may include a lid and the lower portion of the refuse container is sealed with a bottom plate.

Although most refuse containers are fabricated from reactive metals they are frequently located outside and exposed to the elements. Thus, the side walls and the bottom plate are prone to deterioration due to adverse reactions between the steel and materials within and/or outside the refuse container. Reactive fluids, for example, rain, byproducts from the breakdown of organic material, and the like, which are allowed to sit within the refuse container may deteriorate the side walls and bottom plate of the refuse container via oxidative or other deteriorative processes. Once the bottom plate of the refuse container has deteriorated, it must be repaired or the refuse container discarded completely. Conventional refurbishing means include cutting the bottom plate from the refuse container and welding a replacement bottom plate onto the refuse container. Although this temporarily repairs the refuse container, the process is labor intensive and subsequent exposure to the elements may require frequent replacement of the bottom plate of the refuse container for the duration of its lifetime.

Attempts have been made to create polymeric inserts which cover the deteriorated bottom plate of the refuse container. However, such inserts suffer from drawbacks including the need for support bracing. As the polymeric insert is placed within the refuse container, the insert relies at least partially upon the deteriorated bottom plate for support below. If the bottom plate is too deteriorated, support bracing must be installed to support the polymeric insert from underneath. As with the bottom plate, if the support bracing is exposed to the elements it may deteriorate, thus the support bracing may require frequent replacement.

Therefore, a need exists for a refuse container having a cover which is not susceptible to oxidative or other types of deterioration. Furthermore, the need exists for a method to refurbish a deteriorated refuse container by removing the deteriorated portions of the refuse container and connecting a polymeric cover thereto without the need for support bracing, to produce a refurbished refuse container. It is to such methods and apparatuses that the present invention is directed.

### BRIEF DESCRIPTION OF THE SEVERAL VIEWS OF THE DRAWINGS

FIG. 1 is a perspective view of a refuse container having a polymeric cover constructed in accordance with the present invention.

FIG. 2 is an exploded side elevational view of the refuse container of FIG. 1

FIG. 3A is a top plan view of the polymeric cover shown in FIGS. 1 and 2.

FIG. 3B is a cross-sectional view of the polymeric cover of FIG. 3A taken along line 3B-3B.

FIG. 3C is a cross-sectional view of the polymeric cover of FIG. 3A taken along line 3C-3C.

FIG. 4A is a partial perspective view of a deteriorated refuse container.

FIG. 4B is a top plan view of the deteriorated refuse container of FIG. 4A.

FIG. 5 is a perspective view of a polymeric cover including a layer of adhesive.

FIG. 6 is a perspective view of the deteriorated refuse container of FIG. 4A having deteriorated portions removed, the refuse container being associated with the polymeric cover of FIG. 5.

### DETAILED DESCRIPTION OF EXEMPLARY EMBODIMENTS

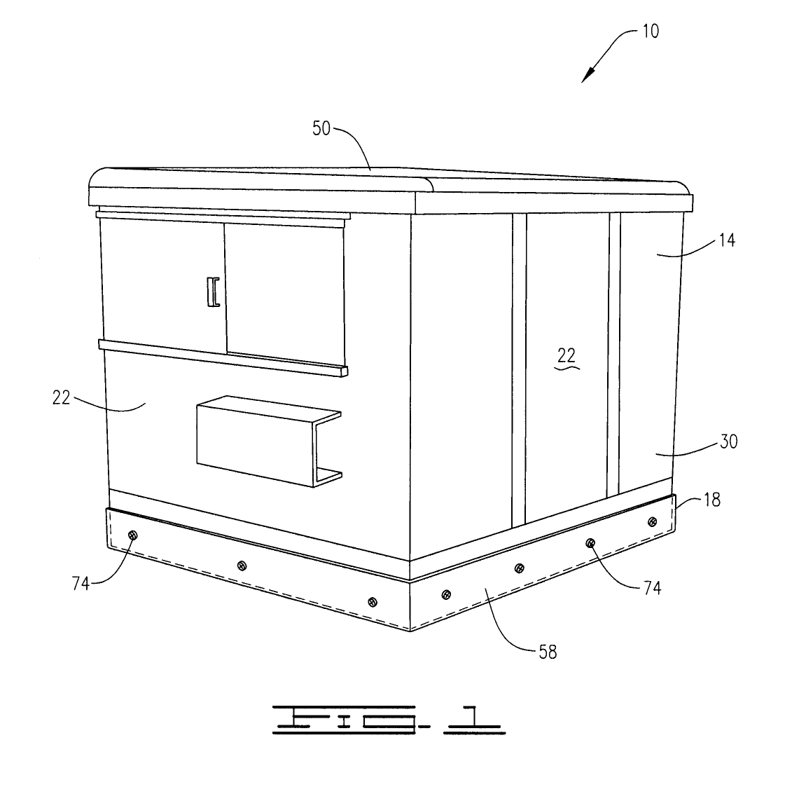

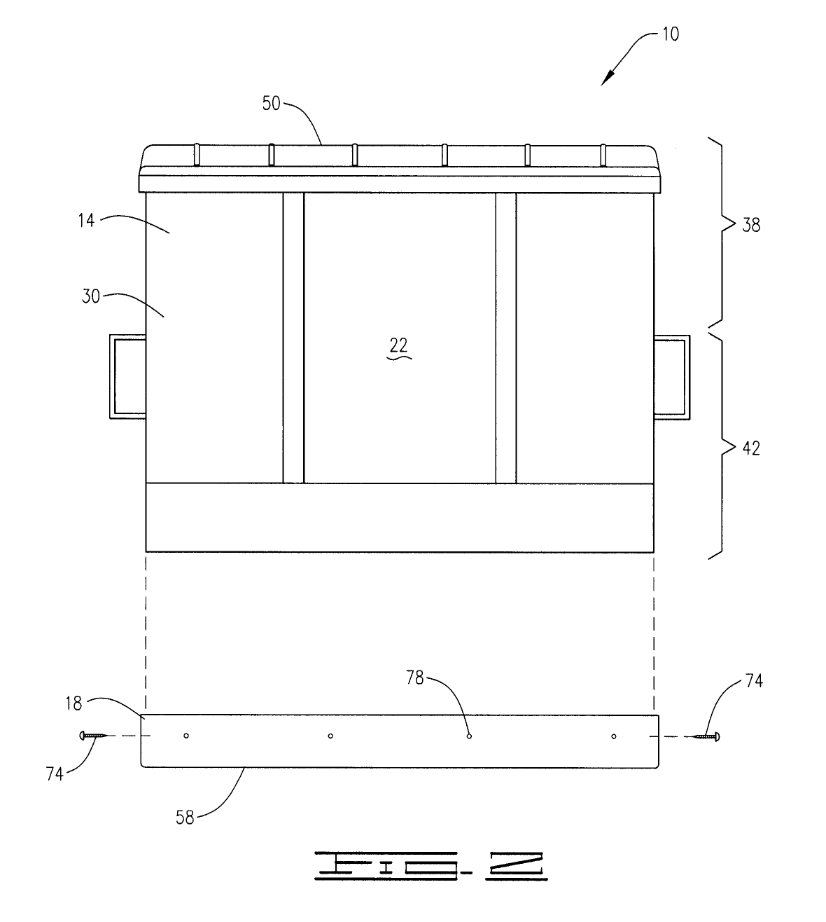

Referring now to the drawings, and more particularly to FIGS. 1 and 2 collectively, shown therein is a refuse container 10 constructed in accordance with the present invention. The refuse container 10 shown is often referred to as a “front loader,” but it should be understood that the invention described herein is applicable to other types of refuse containers, including “rear loaders” and “side loaders.” The refuse container 10 has a metal container body 14 and a polymeric cover 18. The metal container body 14 includes four contiguous side walls 22 connected together to form a substantially square shaped tubular member. Although the metal container body 14 has been disclosed as having a substantially rectangular shape, any one of a number of different geometrical configurations, for example, triangular, circular, square, that would be known to one of ordinary skill in the art with the present disclosure before them are likewise contemplated for use in accordance with the present invention. The metal container body 14 has an exterior surface 30 and an interior surface (not shown). The metal container body 14 includes an upper end 38 and a lower end 42 spaced apart from one another to define the height of the metal container body 14.

The refuse container 10 may optionally include an upper lid or cover 50. The upper cover 50 is hinged to the upper end 38 of the metal container body 14 and is sized to extend across the upper end 38 so as to form an enclosure when joined with the metal container body 14 having the polymeric cover 18.

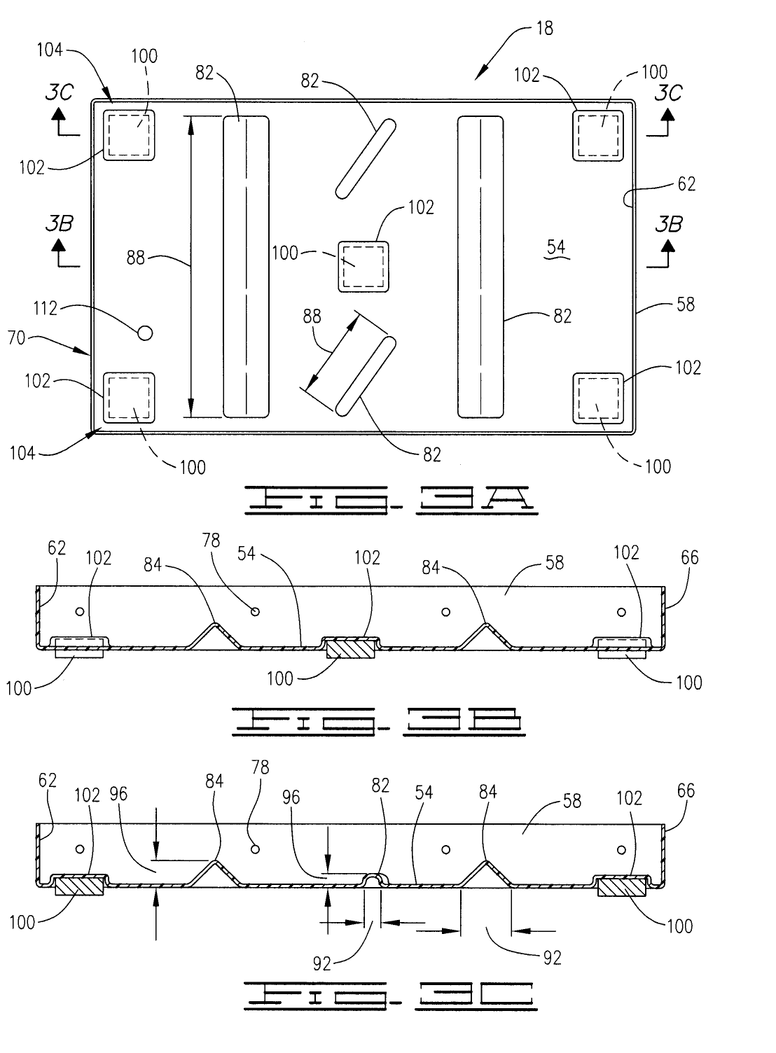

Referring now to FIGS. 3A-3C, the polymeric cover 18 is provided with a bottom 54 and a flange 58. The polymeric cover 18 is constructed from, for example, a plastic, a resin, a plastic polymer (e.g., polyethylene terephthalate, high-density polyethylene, vinyl/polyvinyl chloride, low-density polyethylene, polypropylene, polystyrene, and the like) and/or combinations thereof. The polymeric cover 18 may be fabricated by thermoforming, milling, and/or combinations of these or other suitable methods of manufacturing. It will be understood that although the polymeric cover 18 has been disclosed as being fabricated from a plastic, a resin and/or a plastic polymer, any number of other materials, for example, fiberglass, rubbers, composite materials and the like, which would be known to one of ordinary skill in the art with the present disclosure before them are likewise contemplated for use in accordance with the present invention.

The bottom 54 of the polymeric cover 18 is sized to extend across the lower end 42 of the metal container body 14 so as to close the lower end 42 of the metal container body 14 in order to prevent loss of contents from the refuse container 10.

The flange 58 extends upwardly from the bottom 54 to and has an interior surface 62 and an exterior surface 66. The flange 54 defines a perimeter 70 and is provided to secure the cover 18 to the metal container body 14 and may interface with the metal container body 14 in a variety of ways.

The perimeter 70 of the flange 58 is preferably larger than the perimeter of the metal container body 14 such that the flange 58 fits around the lower end 42 of the metal container body 14. The flange 58 preferably fits over the lower end 42 of the metal container body 14 in such a way that the interior surface 62 of the flange 58 is in a face-to-face relationship with a portion of the exterior surface 30 of the metal container body 14. In a preferred embodiment, the flange 58 has a height of about six inches. It has been found that such a height provides sufficient material with which to attach the flange 58 to the metal container body 14 so as to ensure the integrity of the flange 58 as well as the metal container body 14. It will be appreciated, however, that the height of the flange 58 may be varied.

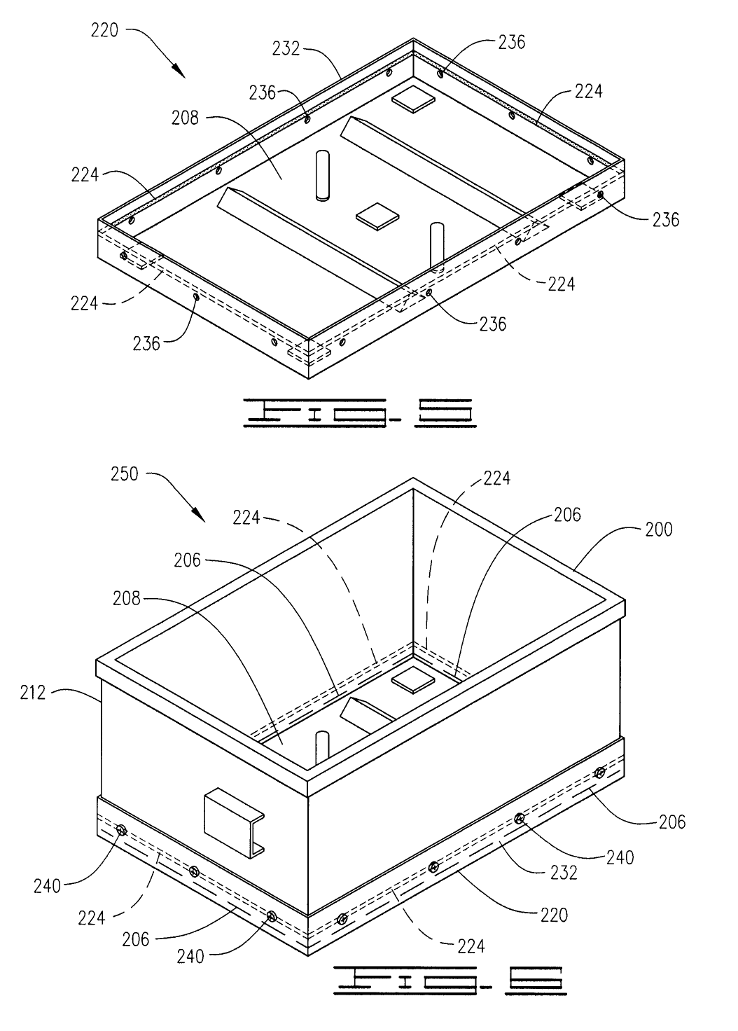

To provide for quick installation, the flange 58 is preferably secured to the lower end 42 of the metal container body 14 by way of one or more fasteners, for example, threaded bolts and nuts, rivets, clips, staples, adhesives and/or combinations thereof. In one embodiment, the flange 58 is secured to the lower end 42 of the metal container body 14 via threaded fasteners 74 inserted through apertures 78 fabricated into the flange 58 and into the metal container body 14. Also, the flange 58 may be secured to the metal container body 14 by additional means such as plastic soldering, compression fitting and the like. Preferably, the fasteners 74 are installed a distance above the lower end 42 of the metal container body 14 so that the fasteners 74 remain above leachate that may accumulate in the refuse container 10. By way of example, if the flange 58 has a height of about six inches, it is preferred that the fasteners 4 be installed about 3½ inches to about 4 inches above the bottom 58 of the polymeric cover 18. A layer of adhesive and/or a seal (see FIGS. 5 and 6) may be disposed between the interior surface 62 of the flange 58 and the exterior surface 30 of the lower end 42 of the metal container body 14 to substantially seal the connection therebetween.

To provide additional integrity to the bottom 54 and thus prevent excessive buckling of the bottom 54 during the unloading process, the bottom 54 of the polymeric cover 18 preferably includes one or more ribs 82. The ribs 82 may be joined to the bottom 54 or fabricated integrally with the bottom 54. Each of the ribs 82 has a length 88, a width 92, and a height 96 that may vary according to design requirements. It will be understood that the positioning and number of ribs 82 may be varied to accommodate refuse containers of different sizes and shapes. In one embodiment, the ribs 82 are fabricated integrally with the bottom 54 so that the ribs 82 are spaced a distance from the flange 58. The ribs 82 shown are upward projecting inverted V-shaped protrusions 84 (see FIGS. 3B and 3C). Although the protrusions 84 have been disclosed as having a substantially inverted V-shape, any number of other shapes, square, semi-circular, irregular, or the like, which would be known to one of ordinary skill in the art with the present disclosure before them are likewise contemplated for use in accordance with the present invention.

The polymeric cover 18 preferably includes a plurality of spacers 100 extending downwardly from the bottom 54 of the polymeric cover 18 to elevate the refuse container 10 above the ground. Spacing the refuse container 10 above the ground aids in preventing physical damage to the bottom 54 of the polymeric cover 18. In one embodiment, the polymeric cover 18 includes spacers 100 at each of the corners 104 of the bottom 54 of the polymeric cover 18 secured within spacer recesses 102 fabricated into the bottom 54. It will be understood that the spacers 100 may be separate components from the polymeric cover 18 (as illustrated in FIGS. 3A-3C), or the spacers 100 may be formed integrally with the bottom 54 during the fabrication of the polymeric cover 18. To facilitate movement of the refuse container 10, each of the spacers 100 may be provided with a caster (not shown).

The refuse container 10 may also optionally include a drain hole 112 (FIG. 3A). The breakdown of material within the refuse container 10 and/or exposure to the elements may create a buildup of potentially reactive fluids which can deteriorate or otherwise damage the bottom 54 of the polymeric cover 18. These potentially reactive fluids within the refuse container 10 may be removed via the drain hole 112. It will be understood that the drain hole 112 may be disposed at any position along the bottom 54 and may be of any shape and/or size.

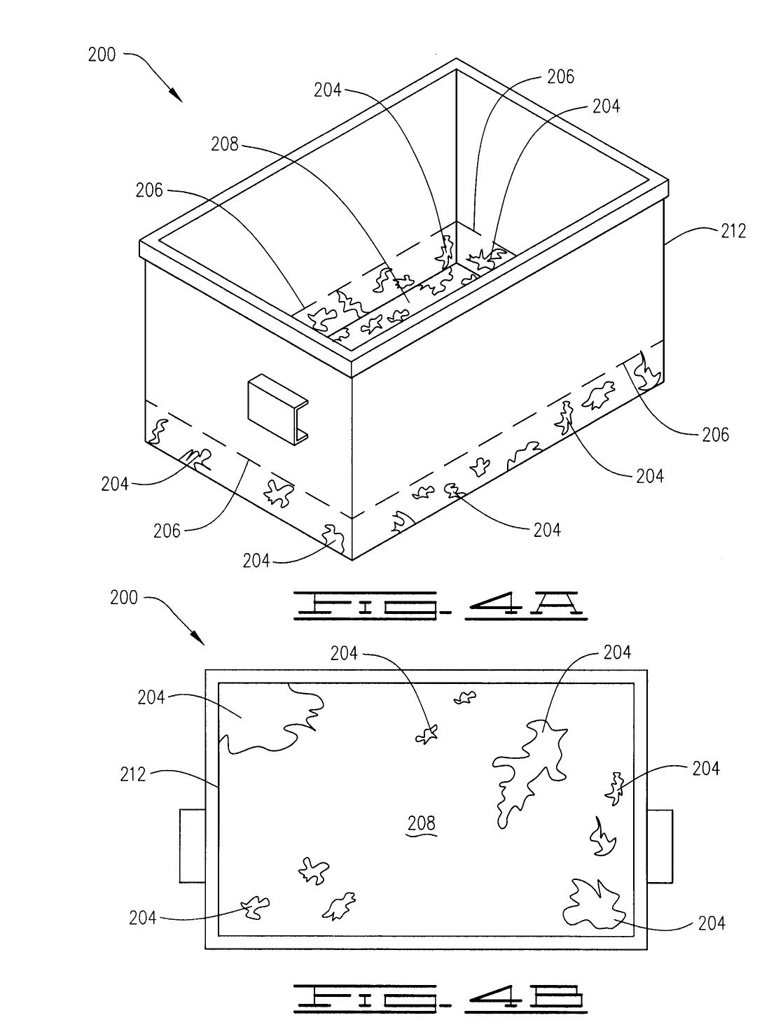

Referring now FIGS. 4A and 6, shown therein is a deteriorated refuse container 200 (FIGS. 4A and 4B) and a refurbished refuse container 250 (FIG. 6). To refurbish the deteriorated refuse container 200, deteriorated portions 204 of the refuse container 200 are removed. In most cases, this step requires only the removal of the bottom 208 of the refuse container 200, although in some cases, where the side walls 212 are also deteriorated, the deteriorated portions 204 of the side walls 212 may be removed as well. By way of non-limiting example, the side walls 212 may be cut along line 206 which is located above the deteriorated portions 204. Once the deteriorated portions 204 have been removed a polymeric cover 220 as described above is connected to the lower end of the refuse container 200. To connect the polymeric cover 220 to the refuse container 200, a layer of adhesive and/or a seal 224 may be applied to the interior surface of a flange 232 of the polymeric cover 220. The refuse container 200 is joined with the polymeric cover 220 such that the flange 232 of the polymeric cover 220 covers at least a portion of the lower end of the refuse container 200. Next, apertures 236 are drilled through the flange 232 and the side walls 212 of the refuse container 200.

Once the apertures 236 have been drilled through the polymeric cover 220 and the side walls 212 of the refuse container 200, the flange 232 of the polymeric cover 220 and refuse container 200 are secured together by inserting threaded bolts 240 through apertures 236 in the flange 232 and the refuse container 220 to produce a refurbished refuse container 250. It will be understood that the step of drilling apertures 236 may be unnecessary if the flange 232 is joined to the side walls 212 of the refuse container 200 with adhesive only, or if rivets are used to secure the flange 232 and the side walls 212 of the refuse container 200.

If the polymeric cover 220 was formed without spacers, optional spacers (see FIG. 3A-3C) may be positioned below the polymeric cover 220 to elevate the refurbished refuse container 250 above the ground. The optional spacers may be connected to the polymeric cover 220 via an adhesive or fastener (not shown) or the polymeric cover 220 may rest on the spacers. Also, as disclosed previously, each of the spacers may include a caster (not shown) such that the refurbished refuse container 250 may translate along the ground.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A refuse container, comprising:
a metal container body having an upper end, a lower end and a side wall extending from the upper end to the lower end, the side wall having an exterior surface; and
a polymeric cover having a bottom sized to extend across the lower end of the metal container body and a flange extending upwardly from the bottom, the flange being connected to the exterior surface of the side wall of the metal container body so as to close the lower end of the metal container body.

2. The refuse container of claim 1, further comprising an upper cover hinged to the upper end of the metal container body to substantially cover the upper end of the metal container body.

3. The refuse container of claim 1, wherein the bottom of the polymeric cover includes one or more ribs disposed thereon for enhancing the rigidity of the bottom of the polymeric cover.

4. The refuse container of claim 3, wherein the one or more ribs include upwardly directed protrusions fabricated into the bottom of the polymeric cover.

5. The refuse container of claim 3, wherein the one or more ribs include strips of a polymeric material connected to an upper surface of the bottom of the polymeric cover.

6. The refuse container of claim 1, further comprising a seal member disposed between an outer surface of the flange and the exterior surface of the side wall of the metal container body.

7. The refuse container of claim 1, wherein the flange is secured to the side wall of the container body via a plurality of fasteners.

8. The refuse container of claim 1, wherein the polymeric cover comprises a plurality of spacers, each of the spacers connected to a bottom surface of the bottom of the polymeric cover.

9. The refuse container of claim 8, wherein the polymeric cover comprises a plurality of casters, each of the casters connected to each of the spacers of the bottom of the polymeric cover.

10. The refuse container of claim 1, wherein the bottom of the polymeric cover includes a drain hole providing fluid communication from within the refuse container outwardly.

11. A polymeric cover in combination with a refuse container, the refuse container comprising a metal container body having an upper end, a lower end, a side wall extending from the upper end to the lower end, the side wall having an exterior surface and an at least partially deteriorated bottom connected to the side wall proximate the lower end, the polymeric cover comprising:
a bottom extended across the lower end of the container body; and
a flange extending upwardly from the bottom, the flange being connected to the exterior surface of the side wall of the metal container body so that the bottom closes the lower end of the metal container body.

12. The combination of claim 11, further comprising an upper cover hinged to the upper end of the metal container body to substantially cover the upper end of the metal container body.

13. The combination of claim 11, wherein the bottom of the polymeric cover includes one or more ribs formed thereon for enhancing the rigidity of the bottom of the polymeric cover.

14. The combination of claim 13, wherein the one or more ribs include upwardly directed protrusions fabricated into the bottom of the polymeric cover.

15. The combination of claim 13 wherein the one or more ribs include strips of a polymeric material connected to an upper surface of the bottom of the polymeric cover.

16. The combination of claim 11, further comprising a seal member disposed between an interior surface of the flange and the exterior surface of the side wall of the metal container body.

17. The combination of claim 11, wherein the flange is secured to the side wall of the metal container body via a plurality of fasteners.

18. The combination of claim 11, wherein the polymeric cover comprises a plurality of spacers, each of the spacers connected to a bottom surface of the bottom of the polymeric cover.

19. The combination of claim 18, wherein the polymeric cover comprises a plurality of casters, each of the casters connected to each of the spacers of the bottom of the polymeric cover.

20. The combination of claim 11, wherein the bottom of the polymeric cover includes a drain hole providing fluid communication from within the refuse container outwardly.

21. A method for refurbishing a refuse container, the refuse container comprising a metal container body having an upper end, a lower end, a side wall extending from the upper end to the lower end, the side wall having an exterior surface and an at least partially deteriorated bottom connected to the side wall proximate the lower end, the method comprising the steps of:
removing the at least partially deteriorated bottom of the refuse container;
obtaining a polymeric cover having a bottom sized to extend over the lower end of the container body and a flange extending upwardly from the bottom; and
connecting the flange of the polymeric cover to the exterior surface of the side wall of the metal container body so as to close the lower end of the metal container body to produce a refurbished refuse container.

22. The method of claim 21, further comprising the step of providing a seal member between an interior surface of the flange and the exterior surface of the side wall before the step of connecting the flange of the polymeric cover to the exterior surface of the refuse container.

23. The method of claim 21, wherein the flange is secured to the side wall of the container body via a plurality of fasteners.

24. The method of claim 21, further comprising the step of spacing the bottom from a ground support surface.

25. The method of claim 24, further comprising attaching a plurality of casters to the bottom.

26. The method of claim 21, wherein the flange is connectable to an interior surface of the side wall of the metal container body.

27. A method for refurbishing a refuse container, the refuse container comprising a metal container body having an upper end, a partially deteriorated lower end, a side wall extending from the upper end to the lower end, the side wall having an exterior surface and an at least partially deteriorated bottom connected to the side wall proximate the lower end, the method comprising the steps of:
removing the at least partially deteriorated bottom of the refuse container by cutting the side wall of the metal container body at a location above the deteriorated portion of the lower portion of the side wall;
obtaining a polymeric cover having a bottom sized to extend over the lower end of the metal container body, the bottom having one or more ribs disposed thereon for enhancing the rigidity of the bottom; and a flange extending upwardly from the bottom, the flange being connectable to the exterior surface of the side wall of the metal container body so as to close the lower end of the metal container body; and
connecting the flange of the polymeric cover to the exterior surface of the side wall of the metal container body so as to close the lower end of the metal container body to produce a refurbished refuse container.

28. The method of claim 27, further comprising the step of providing a seal member between an interior surface of the flange and the exterior surface of the side wall before the step of connecting the flange of the polymeric cover to the exterior surface of the refuse container.

29. The method of claim 27, further comprising the step of fabricating apertures into both the side wall of the metal container body and the flange of the polymeric cover, the apertures of the side wall of the metal container body and apertures of the flange being in axial alignment with one another when the flange is joined with the side wall of the metal container body.

30. The method of claim 29, wherein the step of connecting the flange of the polymeric cover to the exterior surface of the side wall of the metal container body of the refuse container includes inserting a fastener through the axially aligned apertures of the side wall of the metal container body and the flange of the polymeric cover.

31. The refuse container of claim 27, wherein the bottom of the cover includes one or more ribs disposed thereon for enhancing the rigidity of the bottom of the cover.

32. The refuse container of claim 31, wherein the one or more ribs include upwardly directed protrusions fabricated into the bottom of the cover.

33. The refuse container of claim 31, wherein the one or more ribs include strips of a polymeric material connected to an upper surface of the bottom of the cover.

34. The method of claim 27, wherein the flange is connectable to an interior surface of the side wall of the metal container body.
